(19) United States
(12) Patent Application Publication
(10) Pub. No.: US 2022/0227216 A1
(43) Pub. Date: Jul. 21, 2022

(54) MODULAR TRANSMISSION MECHANISM FOR HYBRID POWER SYSTEM, AND HYBRID POWER SYSTEM

(71) Applicants: Chunzu ZHANG, Shanghai (CN); SCHAEFFLER TECHNOLOGIES AG & CO. KG, Herzogenaurach (DE)

(72) Inventor: Chunzu Zhang, Shanghai (CN)

(73) Assignee: SCHAEFFLER TECHNOLOGIES AG & CO. KG, Herzogenaurach (DE)

(21) Appl. No.: 17/606,727

(22) PCT Filed: Apr. 26, 2019
(86) PCT No.: PCT/CN2019/084535

§ 371 Date: Oct. 26, 2021

(51) Int. Cl. B60K 6/387; F16D 25/08; B60K 6/40; B60K 6/26; H02K 5/20; H02K 7/108

(52) U.S. Cl. CPC B60K 6/387; F16D 25/082; B60K 6/40; B60Y 2200/92; H02K 5/203; H02K 7/108; B60K 6/26

(57) ABSTRACT

The present invention provides a modular transmission mechanism for a hybrid power system, and a hybrid power system; the modular transmission mechanism integrates a motor, a rotor support assembly, a clutch, a concentric slave cylinder, and an engine output shaft. On the one hand, the modular transmission mechanism enables an input/output bracket of the clutch to be in drive coupling with the engine output shaft, and the rotor support assembly to be in drive coupling with an input shaft of a transmission; on the other hand, the modular transmission mechanism enables the input/output bracket of the clutch to be in drive coupling with the input shaft of the transmission, and the rotor support assembly to be in drive coupling with the engine output shaft. In this way, the modular transmission mechanism according to the present invention can realize a conversion of the hybrid power system between a P1 architecture and a P2 architecture only by simple adjustment on the structure, thereby reducing the research and development cost and burden consumed by separately developing the P1 architecture and the P2 architecture.

### TECHNICAL FIELD

The present invention relates to a hybrid vehicle and, in particular, to a modular transmission mechanism for a hybrid power system of a vehicle and a hybrid power system comprising the transmission mechanism.

### BACKGROUND

At present, in an existing dual-motor hybrid power system for a vehicle, dual motors are usually arranged in different positions of the hybrid power system, such that the hybrid power system implements different architectures.

As shown in FIG. 1a, in a dual-motor hybrid power system, an output shaft of an engine ICE is directly connected to an input/output shaft of a first motor EM1, the input/output shaft of the first motor EM1 can be in drive coupling with an input shaft of a transmission DHT via engagement of a clutch K0, and an input/output shaft of a second motor EM2 is in drive coupling with an output shaft of the transmission DHT via a gear pair. In this way, the hybrid power system has a P1 architecture (corresponding to a position of the first motor EM1) and a P3 architecture (corresponding to a position of the second motor EM2).

As shown in FIG. 1b, in another dual-motor hybrid power system, an output shaft of an engine ICE can be in drive coupling with an input/output shaft of a first motor EM1 via engagement of a clutch K0, the input/output shaft of the first motor EM1 is directly connected to the input shaft of the transmission DHT, and the input/output shaft of the second motor EM2 is in drive coupling with the output shaft of the transmission DHT via the gear pair. In this way, the hybrid power system implements a P2 architecture (corresponding to a position of the first motor EM1) and a P3 architecture (corresponding to a position of the second motor EM2).

In the above-mentioned two commonly-used dual-motor hybrid power systems, given that the first motor EM1 is arranged in different positions, it is usually necessary to separately design a power transmission mechanism corresponding to the P1 architecture and the P2 architecture, which greatly adds to the research and development cost and burden.

### SUMMARY

The present invention has been made in view of the deficiencies of the prior art as described above. An object of the present invention is to provide a novel modular transmission mechanism for a hybrid power system. The modular transmission mechanism can easily implement a P1 architecture and a P2 architecture in the hybrid power system, thereby reducing the research and development cost and burden consumed by separate development in the above-mentioned prior art. Another object of the present invention is to provide a hybrid power system comprising the modular transmission mechanism.

To achieve the above-mentioned objects, the present invention adopts the following technical solutions.

The present invention provides a modular transmission mechanism for a hybrid power system as follows, comprising:

a motor comprising a stator and a rotor located on a radial inside of the stator and capable of rotating relative to the stator;

a rotor support assembly fixedly connected to the rotor and located on a radial inside of the rotor;

a clutch located on the radial inside of the rotor and comprising a plurality of pressure plates, a plurality of friction disks, and an input/output bracket, wherein the plurality of pressure plates are capable of engaging the plurality of friction disks to enable the rotor support assembly to be in drive coupling with the input/output bracket;

a concentric slave cylinder integrally fixed relative to the stator and comprising a piston, wherein the piston is capable of exerting pressure to the pressure plate to enable the plurality of friction disks to be engaged with one another;

an engine output shaft located on radial insides of both the concentric slave cylinder and the rotor support assembly; and

an output assembly,

wherein the engine output shaft is connected to the input/output bracket and the output assembly is connected to the rotor support assembly; or

the engine output shaft is connected to the rotor support assembly and the output assembly is connected to the input/output bracket.

Preferably, the rotor support assembly comprises a rotor bracket and a rotor flange, the rotor bracket is fixedly connected to the rotor, the rotor flange is located on a radial inside of the rotor bracket and is fixedly connected to the rotor bracket, and the clutch is located between the rotor bracket and the rotor flange.

More preferably, the rotor flange comprises a rotor flange radial portion extending in a radial direction and a rotor flange axial portion extending from a radial inside end of the rotor flange radial portion toward one axial side, the clutch is located on a radial outside of the rotor flange axial portion, and the plurality of pressure plates are in drive coupling with the rotor flange axial portion in a circumferential direction.

More preferably, the rotor flange axial portion is further provided with an axial stopper, and the axial stopper is located in a position on one axial side of the pressure plate closest to one axial side among the plurality of pressure plates.

More preferably, the mass of at least one pressure plate located at the center among the plurality of pressure plates is greater than that of the other pressure plates.

More preferably, a part of a cylinder body of the concentric slave cylinder is located on the radial inside of the rotor flange axial portion, and the modular transmission mechanism comprises at least one bearing located between the rotor flange axial portion and the cylinder body and at least two bearings located between the cylinder body and the engine output shaft.

More preferably, the modular transmission mechanism further comprises a housing, wherein the housing is fixed relative to an engine of the hybrid power system, the housing comprises a housing radial portion extending in a radial direction, and a first housing axial portion and a second housing axial portion extending from a radial outside end of the housing radial portion toward the other axial side and one axial side, respectively, and

the cylinder body of the concentric slave cylinder is fixed on the housing radial portion and the motor is located on a radial inside of the second housing axial portion.

More preferably, the modular transmission mechanism further comprises a cooling jacket, wherein the cooling jacket is located on the radial inside of the second housing axial portion and fixed to the second housing axial portion, and the stator is located on a radial inside of the cooling jacket and fixed to the cooling jacket.

The present invention further provides a hybrid power system as follows, comprising:

an engine in drive coupling with the engine output shaft;

a transmission comprising a transmission input shaft; and

the modular transmission mechanism for a hybrid power system according to any one of the above-mentioned technical solutions,

wherein the engine output shaft is fixedly connected to the input/output bracket, and the rotor support assembly is in drive coupling with the transmission input shaft via the output assembly.

The present invention further provides a hybrid power system as follows, comprising:

an engine in drive coupling with the engine output shaft;

a transmission comprising a transmission input shaft; and

the modular transmission mechanism for a hybrid power system according to any one of the above-mentioned technical solutions,

wherein the engine output shaft is fixedly connected to the rotor support assembly, and the input/output bracket is in drive coupling with the transmission input shaft via the output assembly.

By adopting the above-mentioned technical solutions, the present invention provides a novel modular transmission mechanism for a hybrid power system, and a hybrid power system comprising the modular transmission mechanism. The modular transmission mechanism integrates a motor, a rotor support assembly, a clutch, a concentric slave cylinder, and an engine output shaft. On the one hand, the modular transmission mechanism enables an input/output bracket of the clutch to be in drive coupling with the engine output shaft, and the rotor support assembly to be in drive coupling with an input shaft of a transmission; on the other hand, the modular transmission mechanism enables the input/output bracket of the clutch to be in drive coupling with the input shaft of the transmission, and the rotor support assembly to be in drive coupling with the engine output shaft. In this way, the modular transmission mechanism according to the present invention can realize a conversion of the hybrid power system between a P1 architecture and a P2 architecture only by simple adjustment on the structure, thereby reducing the research and development cost and burden consumed by separately developing the P1 architecture and the P2 architecture.

### BRIEF DESCRIPTION OF THE DRAWINGS

FIG. 1a is a schematic diagram illustrating a topological connection structure of a dual-motor hybrid power system in the prior art, wherein the hybrid power system has a P1 architecture and a P3 architecture; and FIG. 1b is a schematic diagram illustrating a topological connection structure of another dual-motor hybrid power system in the prior art, wherein the hybrid power system has a P2 architecture and a P3 architecture.

FIG. 2 is a schematic partial structural diagram illustrating the implementation of a hybrid power system with a P2 architecture by using a modular transmission mechanism according to the present invention, wherein the structure of the modular transmission mechanism according to the present invention is mainly illustrated in the form of a sectional view, and section lines of each component are omitted.

FIG. 3 is a schematic partial structural diagram illustrating the implementation of a hybrid power system with a P1 architecture by using a modular transmission mechanism according to the present invention, wherein the structure of the modular transmission mechanism according to the present invention is mainly illustrated in the form of a sectional view, and section lines of each component are omitted.

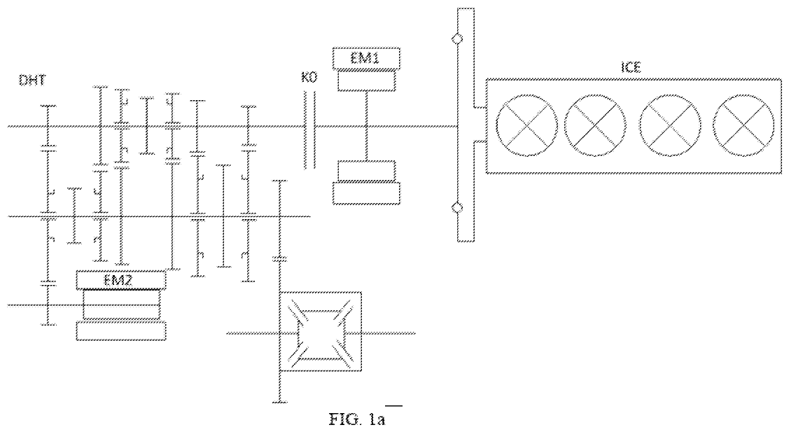

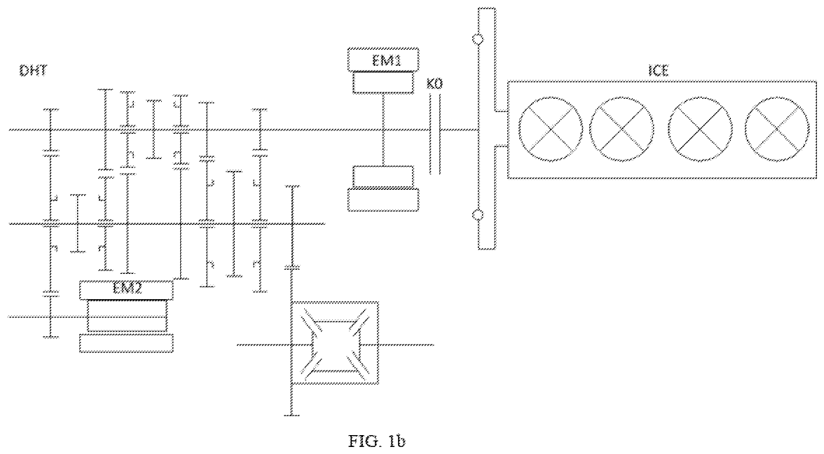

### DETAILED DESCRIPTION

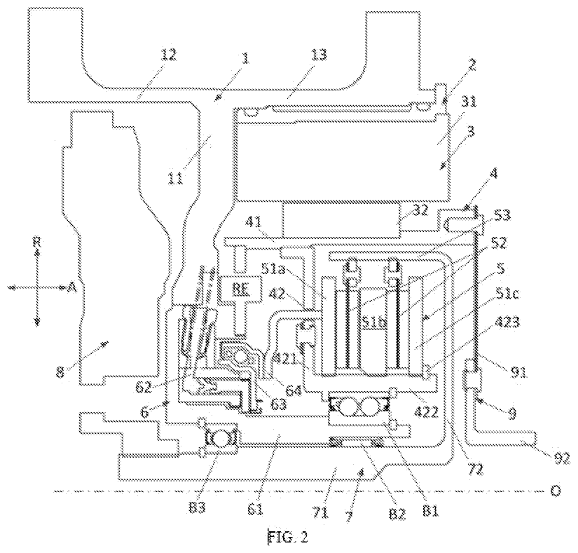

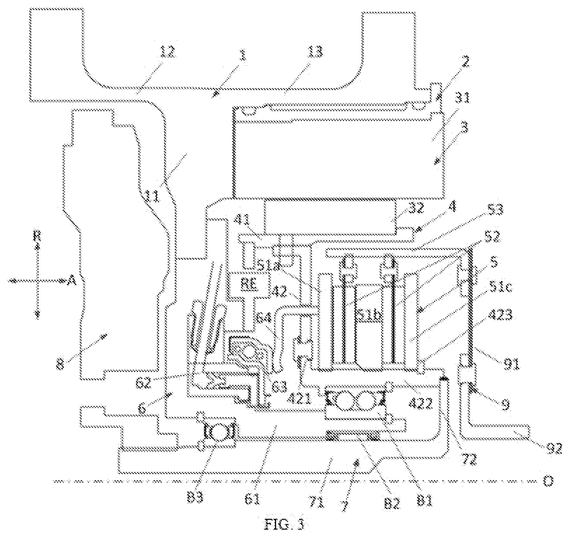

Exemplary embodiments of the present invention will be described below with reference to the drawings. It should be noted that in the present invention, “axial direction”, “radial direction” and “circumferential direction” refer to an axial direction, a radial direction and a circumferential direction of an engine output shaft, respectively. “One axial side” refers to the right side in FIG. 2 and FIG. 3, “the other axial side” refers to the left side in FIG. 2 and FIG. 3, “radial outside” refers to the upper side in FIG. 2 and FIG. 3 (i.e., the side away from a central axis O), and “radial inside” refers to the lower side in FIG. 2 and FIG. 3 (i.e., the side close to the central axis O).

A hybrid power system with a P2 architecture implemented by using a modular transmission mechanism for a hybrid power system according to the present invention will be described below first.

(Hybrid Power System with the P2 Architecture)

The hybrid power system with the P2 architecture according to the present invention comprises a modular transmission mechanism for a hybrid power system according to the present invention, an engine (not shown), a transmission (not shown), and the like.

As shown in FIG. 2, the modular transmission mechanism for a hybrid power system comprises a housing 1, a cooling jacket 2, a motor 3, a rotor support assembly 4, a clutch 5, a concentric slave cylinder 6, an engine output shaft 7, a shock absorber 8 and an output assembly 9 that are assembled together, and all the above-mentioned components are assembled together in a coaxial manner.

Specifically, the housing 1 of the modular transmission mechanism is fixed to an engine body or a transmission housing by, for example, a bolt, such that the housing 1 is fixed relative to the engine and the transmission of the hybrid power system.

The housing 1 comprises a housing radial portion 11, a first housing axial portion 12 and a second housing axial portion 13 that are integrally formed. The housing radial portion 11 extends roughly in a radial direction R, and the first housing axial portion 12 and the second housing axial portion 13 extend from a radial outside end of the housing radial portion 11 toward the other axial side and one axial side in an axial direction A, respectively, such that a space entirely surrounded by the first housing axial portion 12 and the second housing axial portion 13 is partitioned by the housing radial portion 11 into two parts.

Furthermore, the cooling jacket 2 is located on a radial inside of the second housing axial portion 13 and fixed to the second housing axial portion 13, and a flow channel for a cooling liquid (such as water) is formed between the cooling jacket 2 and the second housing axial portion 13 to enable the cooling jacket 2 to cool a stator 31 of the motor 3. In addition, the cooling jacket 2 can further support the stator 31.

Furthermore, the motor 3 comprises the stator 31 and a rotor 32 located on a radial inside of the stator 31 and capable of rotating relative to the stator 31. The stator 31 is located on a radial inside of the cooling jacket 2 and fixed to the cooling jacket 2, and the rotor 32 can rotate relative to the stator 31 in a magnetic field generated by the stator 31, thereby outputting a driving force/torque.

Furthermore, the rotor support assembly 4 is fixedly connected to the rotor 32 and located on a radial inside of the rotor 32, and the rotor support assembly 4 is configured to transmit the driving force/torque from the rotor 32 while supporting the rotor 32 from the radial inside. Specifically, the rotor support assembly 4 comprises a rotor bracket 41 and a rotor flange 42 that are fixed to each other.

The rotor bracket 41 is located on the radial inside of the rotor 32. The rotor bracket 41 is directly and fixedly connected to the rotor 32 through, for example, interference fit, and the rotor bracket 41 is configured to support the rotor 32.

The rotor flange 42 is located on a radial inside of the rotor bracket 41 and fixedly connected to the rotor bracket 41, such that the rotor flange 42 can support the rotor bracket 41 and the rotor 32. The rotor flange 42 comprises a rotor flange radial portion 421 extending in the radial direction and a rotor flange axial portion 422 extending from a radial inside end of the rotor flange radial portion 421 toward one axial side. A radial outside end of the rotor flange radial portion 421 is fixedly connected to the rotor bracket 41. The rotor flange axial portion 422 overlaps the rotor bracket 41 in the axial direction A, such that the rotor bracket 41, the rotor flange radial portion 421 and the rotor flange axial portion 422 surround and form an installation space for the clutch 5.

In addition, the rotor flange axial portion 422 is further provided with an axial stopper 423 configured to axially position the clutch 5.

Furthermore, the clutch 5 is located between the rotor bracket 41 and the rotor flange 42, and is specifically installed in the above-mentioned installation space surrounded and formed by the rotor bracket 41, the rotor flange radial portion 421 and the rotor flange axial portion 422. Therefore, the clutch 5 is located on one axial side of the rotor flange radial portion 421 and on a radial outside of the rotor flange axial portion 422.

The clutch 5 comprises three pressure plates parallel to and spaced from one another (a first pressure plate 51a located on the other axial side, a third pressure plate 51c located on one axial side and a second pressure plate 51b located between the first pressure plate 51a and the third pressure plate 51c), a plurality of friction disks 52, and an input/output bracket 53. The plurality of friction disks 52 are located between the three pressure plates 51a, 51b and 51c. Preferably, some friction disks 52 of the plurality of friction disks 52 are fixed to the pressure plates 51a, 51b and 51c, and the other friction disks 52 are fixed to the input/output bracket 53. The three pressure plates 51a, 51b and 51c enable the plurality of friction disks 52 to be in drive coupling/uncoupling with one another. Furthermore, preferably, the friction disks 52 fixed to the input/output bracket 53 are double-sided friction disks. The three pressure plates 51a, 51b and 51c are further always in drive coupling with the rotor support assembly 4 in a circumferential direction, specifically, the three pressure plates 51a, 51b and 51c are always in drive coupling with the rotor flange axial portion 422 through splines. The axial stopper 423 arranged on the rotor flange axial portion 422 is located in a position on one axial side of the third pressure plate 51c closest to one axial side among the three pressure plates 51a, 51b and 51c, so as to axially limit the clutch 5 from one axial side. Since the three pressure plates 51a, 51b and 51c are in drive coupling with the rotor flange 42 instead of being directly connected to the rotor bracket 41, heat generated by the clutch 5 is prevented from being directly transferred to the rotor 32, and thus the influence of the heat generated by the clutch 5 on the rotor 32 is very slight.

In addition, among the three pressure plates 51a, 51b and 51c, the mass of the second pressure plate 51b is much greater than that of the first pressure plate 51a and that of the third pressure plate 51c, such that the heat capacity of the whole clutch 5 is improved.

Furthermore, the concentric slave cylinder 6 comprises a cylinder body 61 fixed to a radial inside end of the housing radial portion 11, a modular clutch actuator 62, a release bearing 63, and a piston 64.

One part of the cylinder body 61 of the concentric slave cylinder 6 extends from the radial inside end of the housing radial portion 11 toward the radial inside roughly in the radial direction R, and the other part of the cylinder body 61 extends from the radial inside end of the above-mentioned part toward one axial side in the axial direction A, such that the other part of the cylinder body 61 is located on a radial inside of the rotor flange axial portion 422 and overlaps the rotor flange axial portion 422 in the axial direction A.

The modular clutch actuator 62 is arranged in the housing 1, and by controlling high-pressure oil, the modular clutch actuator 62 enables the release bearing 63 to exert or cancel an axial pressure on the piston 64, so as to control the engagement/disengagement of the clutch 5. The modular clutch actuator 62 has the same structure as similar mechanisms in the prior art, and thus will not be described in detail in the present specification.

An inner ring of the release bearing 63 abuts against the modular clutch actuator 62 in the axial direction A, and an outer ring of the release bearing 63 abuts against the piston 64 in the axial direction A, such that the release bearing 63 can successfully transmit the axial pressure from the modular clutch actuator 62 to the piston 64.

One part of the piston 64 is for the outer ring of the release bearing 63 to abut against, and the other part thereof passes through a through hole formed in the rotor flange radial portion 421 and presses against the first pressure plate 51a from the other axial side, such that the piston 64 can cooperate with the axial stopper 423 arranged on the rotor flange axial portion 422 to axially limit the clutch 5.

In this way, when the release bearing 63 is driven by the modular clutch actuator 62 to exert the axial pressure to the piston 64 toward one axial side, the piston 64 exerts pressure to the first pressure plate 51a toward one axial side until the plurality of friction disks 52 between the three pressure plates 51a, 51b and 51c are fully engaged with one another, such that the clutch 5 is engaged; when the release bearing 63 cancels the above-mentioned axial pressure exerted to the piston 64, the friction disks 52 between the three pressure plates 51a, 51b and 51c can be disengaged from one another under the action of, for example, a return spring (not shown), such that the clutch 5 is disengaged.

Furthermore, the engine output shaft 7 is located on radial insides of both the concentric slave cylinder 6 and the rotor support assembly 4. The engine output shaft 7 comprises a shaft portion 71 linearly extending in the axial direction A and a central flange 72 fixed to one axial end of the shaft portion 71, and the central flange 72 extends in the radial direction R. A radial outside end of the central flange 72 is fixed to the input/output bracket 53 of the clutch 5.

Furthermore, the shock absorber 8 is fixed to the other axial end of the shaft portion 71 of the engine output shaft 7, and the shock absorber 8 is located on the other axial side of the housing radial portion 11 and the other axial side of the concentric slave cylinder 6 and located on a radial inside of the first housing axial portion 12; and the shock absorber 8 is configured to attenuate torsional vibration of the engine such that a driving force/torque from the engine can be transmitted to the engine output shaft 7 as steadily as possible.

Furthermore, the output assembly 9 comprises a flexible plate 91 and a hub core 92 of the flexible plate that are connected to each other. A radial outside end of the flexible plate 91 is fixed to the rotor bracket 41 through, for example, a screw, and a radial inside end of the flexible plate 91 is fixed to the hub core 92 of the flexible plate. The hub core 92 of the flexible plate is configured to be in drive coupling with an input shaft of the transmission.

In addition, in order to ensure that the rotor flange 42 is rotatably supported by the cylinder body 61 relative to the cylinder body 61 of the concentric slave cylinder 6, the modular transmission mechanism comprises a bearing (double-row ball bearing) B1 located between the rotor flange axial portion 422 and the cylinder body 61. Similarly, in order to ensure that the cylinder body 61 of the concentric slave cylinder 6 is rotatably supported by the engine output shaft 7 relative to the engine output shaft 7, the modular transmission mechanism comprises two bearings (a single-row deep groove ball bearing and a needle bearing) B3 and B2 located between the cylinder body 61 and the engine output shaft 7. Outer rings and inner rings of the above-mentioned bearings are all axially limited by appropriate structures.

In this way, in the hybrid power system with the P2 architecture shown in FIG. 2,

on the one hand, the engine output shaft 7 of the modular transmission mechanism is in drive coupling with a crankshaft of the engine, such that the driving force/torque from the engine can be transmitted to the engine output shaft 7, and the engine output shaft 7 is further fixedly connected to the input/output bracket 53 of the clutch 5, such that the driving force/torque from the engine output shaft 7 can be directly transmitted to the rotor support assembly 4 when the clutch 5 is engaged; and

on the other hand, the rotor support assembly 4 is fixedly connected to the rotor 32, such that the driving force/torque from the rotor 32 of the motor 3 can be directly transmitted to the rotor support assembly 4, such that the driving force/torque from the engine output shaft 7 and the driving force/torque from the rotor 32 of the motor 3 can be combined at the rotor support assembly 4. Furthermore, the rotor support assembly 4 of the modular transmission mechanism is in drive coupling with the input shaft of the transmission via the output assembly 9. Therefore, the combined driving force/torque can be transmitted to the input shaft of the transmission via the output assembly 9.

More specifically, in the hybrid power system with the P2 architecture shown in FIG. 2, a transmission path of the driving force/torque from the engine is as follows: the engine output shaft 7→the input/output bracket 53 of the clutch 5→the friction disks 52 of the clutch 5→the pressure plates 51a, 51b and 51c of the clutch 5→the rotor flange 42→the rotor bracket 41→the flexible plate 91→the hub core 92 of the flexible plate→the input shaft of the transmission; and a transmission path of the driving force/torque from the motor 3 is as follows: the rotor 32→the rotor bracket 41→the flexible plate 91→the hub core 92 of the flexible plate→the input shaft of the transmission.

The hybrid power system with the P2 architecture implemented by using the modular transmission mechanism for a hybrid power system according to the present invention is described above, and a hybrid power system with a P1 architecture implemented by using the modular transmission mechanism for a hybrid power system according to the present invention will be described below.

(Hybrid Power System with the P1 Architecture)

The hybrid power system with the P1 architecture comprises a modular transmission mechanism for a hybrid power system according to the present invention, an engine (not shown), a transmission (not shown), and the like, wherein the modular transmission mechanism for a hybrid power system according to the present invention shown in FIG. 3 has substantially the same basic structure as the modular transmission mechanism for a hybrid power system according to the present invention shown in FIG. 2. In order to implement the hybrid power system with the P1 architecture, only a connection relationship between some components is changed.

Specifically, as shown in FIG. 3, the central flange 72 of the engine output shaft 7 is fixedly connected to the rotor flange axial portion 422 of the rotor support assembly 4, instead of being directly and fixedly connected to the input/output bracket 53 of the clutch 5; in addition, the output assembly 9 is fixedly connected to the input/output bracket 53 of the clutch 5, instead of being directly and fixedly connected to the rotor support assembly 4. In this way, the driving force/torque from the engine output shaft 7 can be directly transmitted to the rotor support assembly 4 without passing through the clutch 5, the driving force/torque from the rotor 32 and the driving force/torque from the engine output shaft 7 are combined at the rotor support assembly 4, and then the combined driving force/torque is transmitted to the output assembly 9 via the engagement of the clutch 5.

More specifically, in the hybrid power system with the P1 architecture shown in FIG. 3, the transmission path of the driving force/torque from the engine is as follows: the engine output shaft 7→the rotor flange 42→the pressure plates 51a, 51b and 51c of the clutch 5→the friction disks 52 of the clutch 5→the input/output bracket 53 of the clutch 5→the flexible plate 91→the hub core 92 of the flexible plate→the input shaft of the transmission; and the transmission path of the driving force/torque from the motor 3 is as follows: the rotor 32→the rotor bracket 41→the rotor flange 42→the pressure plates 51a, 51b and 51c of the clutch 5→the friction disks 52 of the clutch 5→the input/output bracket 53 of the clutch 5→the flexible plate 91→the hub core 92 of the flexible plate→the input shaft of the transmission.

It can be learned that, due to the adoption of the modular transmission mechanism for a hybrid power system according to the present invention, the hybrid power system can be converted between the P1 architecture and the P2 architecture with only few changes in the structure.

Certainly, the present invention is not limited to the above-mentioned embodiments, and those skilled in the art can make various modifications to the above-mentioned embodiments of the present invention without departing from the scope of the present invention under the teaching of the present invention.

(i) In the above-mentioned description, only an operating mode in which the engine and the motor of each hybrid power system are jointly used for driving is described. The charging of a battery through the motor by using the driving force/torque from the engine can be implemented by appropriately controlling the engagement/disengagement of the clutch, which will not be further described herein.

(ii) Since the clutch 5 of the modular transmission mechanism for a hybrid power system according to the present invention is arranged on the radial inside of the motor 3, which makes the motor 3 and the clutch 5 overlap in the axial direction A, this arrangement reduces a lateral dimension of the entire hybrid power system compared with a mode of side-by-side configuration of the clutch 5 and the motor 3 in the prior art.

(iii) Although not described above, the modular transmission mechanism for a hybrid power system according to the present invention may be further provided with a revolution speed sensor RE. The revolution speed sensor RE may be arranged on the cylinder body 61 of the concentric slave cylinder 6 and the rotor bracket 41 and configured to sense the revolving speed of the rotor 32.

(iv) Although not described above, the clutch 5 of the modular transmission mechanism for a hybrid power system according to the present invention can adjust various parameters of the clutch based on actual needs (torque capacity and heat capacity of the clutch 5).

(v) Although not described above, in a specific but non-limiting example, an outer diameter of the stator 31 is 277 mm, an axial dimension of the stator 31 is about 80 mm, and an inner diameter of the rotor 32 is 182 mm.

(vi) In the present invention, existing products can be used as the concentric slave cylinder 6 (modular clutch actuator 62), the shock absorber 8 and the output assembly 9 to reduce costs.

### LIST OF REFERENCE NUMERALS

ICE engine
EM1 first motor
EM2 second motor
K0 clutch
DHT transmission
1 housing
11 housing radial portion
12 first housing axial portion
13 second housing axial portion
2 cooling jacket
3 motor
31 stator
32 rotor
4 rotor support assembly
41 rotor bracket
42 rotor flange
421 rotor flange radial portion
422 rotor flange axial portion
423 axial stopper
5 clutch
51a first pressure plate
51b second pressure plate
51c third pressure plate
52 friction disks
53 input/output bracket
6 concentric slave cylinder
61 cylinder body
62 modular clutch actuator
63 release bearing
64 piston
7 engine output shaft
71 shaft portion
72 central flange
8 shock absorber
9 output assembly
91 flexible plate
92 hub core of a flexible plate
RE revolution speed sensor
A axial direction
R radial direction
O central axis

1-10. (canceled)

11. A modular transmission mechanism for a hybrid power system, the modular transmission mechanism comprising:
a motor comprising a stator and a rotor located on a radial inside of the stator;
a rotor support assembly fixedly located on a radial inside of the rotor;
a clutch located on the radial inside of the rotor and configured to enable the rotor support assembly to be in drive coupling with an input/output bracket;
a concentric slave cylinder integrally fixed relative to the stator and comprising a piston configured to cause the clutch to become engaged;
an engine output shaft located on radial insides of both the concentric slave cylinder and the rotor support assembly; and
an output assembly.

12. The modular transmission mechanism of claim 11, wherein the engine output shaft is connected to the input/output bracket and the output assembly is connected to the rotor support assembly.

13. The modular transmission mechanism of claim 11, wherein the engine output shaft is connected to the rotor support assembly and the output assembly is connected to the input/output bracket.

14. The modular transmission mechanism of claim 11, wherein the clutch comprises a plurality of pressure plates, a plurality of friction disks, and the input/output bracket; and wherein the plurality of pressure plates are configured to engage the plurality of friction disks so as to enable the rotor support assembly to become drive coupled with the input/output bracket.

15. The modular transmission mechanism of claim 14, wherein the piston is configured to exert pressure onto a first of the plurality of pressure plates to cause the plurality of friction disks to become engaged with one another.

16. The modular transmission mechanism of claim 15, wherein the rotor support assembly comprises a rotor bracket that is coupled to the rotor and a rotor flange that is coupled to the rotor bracket and disposed on a radial inside of the rotor bracket.

17. The modular transmission mechanism of claim 16, wherein the clutch is located between the rotor bracket and the rotor flange.

18. The modular transmission mechanism of claim 17, wherein the rotor flange comprises a rotor flange radial portion extending in a radial direction and a rotor flange axial portion extending from a radial inside end of the rotor flange radial portion toward one axial side.

19. The modular transmission mechanism of claim 18, wherein the clutch is located on a radial outside of the rotor flange axial portion; and wherein the plurality of pressure plates are drive coupled to the rotor flange axial portion in a circumferential direction.

20. The modular transmission mechanism of claim 18, wherein the rotor flange axial portion includes an axial stopper that is located on one axial side of the plurality of pressure plates.

21. The modular transmission mechanism of claim 20, wherein the concentric slave cylinder includes a cylindrical body that is located on a radial inside of the rotor flange axial portion.

22. The modular transmission mechanism of claim 21, wherein at least one bearing is located between the rotor flange axial portion and the cylinder body; and wherein at least two bearings are located between the cylinder body and the engine output shaft.

23. A modular transmission mechanism for a hybrid power system, the modular transmission mechanism comprising:
a motor comprising a stator and a rotor located on a radial inside of the stator;
a rotor support assembly fixedly located on a radial inside of the rotor;
a clutch that enables the rotor support assembly to be in drive coupling with an input/output bracket;
a concentric slave cylinder that causes the clutch to become engaged;
an engine output shaft located on radial insides of both the concentric slave cylinder and the rotor support assembly; and
a housing that is coupled with an engine comprising the hybrid power system.

24. The modular transmission mechanism of claim 23, wherein the housing comprises: a housing radial portion extending in a radial direction; a first housing axial portion extending from a radial outside end of the housing radial portion away from the stator toward an axial side; and a second housing axial portion extending from a radial outside end of the housing radial portion toward the motor.

25. The modular transmission mechanism of claim 24, wherein the housing radial portion is fixed to the cylinder body of the concentric slave cylinder and the second housing axial portion is located on a radial outside of the motor.

26. The modular transmission mechanism of claim 24, further comprising a cooling jacket that is fixed to a radial inside of the second housing axial portion and fixed to a radial outside of the stator.

27. A method for a hybrid power system, comprising:
drive coupling an engine with an engine output shaft;
providing a transmission that includes a transmission input shaft;
configuring a modular transmission mechanism for a hybrid power system; and
communicating driving force and torque from the engine output shaft to the transmission input shaft.

28. The method of claim 27, wherein configuring the modular transmission mechanism comprises:
configuring a motor that includes a stator and a rotor located on a radial inside of the stator;
locating a rotor support assembly fixedly on a radial inside of the rotor;
locating a clutch on the radial inside of the rotor;
configuring the clutch to enable the rotor support assembly drive couple with an input/output bracket;
fixating a concentric slave cylinder relative to the stator;
configuring a piston comprising the concentric slave cylinder to cause the clutch to become engaged;
locating the engine output shaft on radial insides of both the concentric slave cylinder and the rotor support assembly; and
configuring an output assembly to couple with the transmission input shaft.

29. The method of claim 28, wherein communicating driving force and torque includes fixedly connecting the engine output shaft to the input/output bracket, and drive coupling the rotor support assembly with the transmission input shaft by way of the output assembly.

30. The method of claim 28, wherein communicating driving force and torque includes fixedly connecting the engine output shaft to the rotor support assembly, and drive coupling the input/output bracket with the transmission input shaft by way of the output assembly.
